(19) United States
(12) Patent Application Publication
(10) Pub. No.: US 2022/0311264 A1
(43) Pub. Date: Sep. 29, 2022

(54) Grayson Range Extender(GRE) 2.0:

(71) Applicant: Michael Grayson, Jamaica, NY (US)

(72) Inventor: Michael Grayson, Jamaica, NY (US)

(21) Appl. No.: 17/210,654

(22) Filed: Mar. 24, 2021

(51) Int. Cl. H02J 7/14; H02K 7/18; H02K 11/00; B60L 8/00; B60L 53/00; F03D 9/32

(52) U.S. Cl. CPC H02J 7/14; H02K 7/183; H02K 11/0094; B60L 8/006; B60L 53/00; F03D 9/32; F05B 2220/706

(57) ABSTRACT

A fluid dynamic kinetic energy-based frictionless type generator of a range extender and recharger for an electric vehicle or device and the production of electricity is characterized by converting fluid motion into electric energy. This device uses the drag force acting opposite to the relative motion of objects moving with respect to a surrounding fluid. This force can exist between two fluid layers or a fluid and a solid surface. The device comprises a cylinder covered with paddles, air ducting ramp, permanent magnets, armature winding, charge controller and battery bank. It's a frictionless, high efficiency, brushless generator design that utilizes kinetic energy produced by drag, pressure, friction, fluid resistance, fluid dynamics, aerodynamics, wind, and or motion together with the device itself to create a frictionless brushless generator that will deliver power to the engine directly, the enclosed battery bank or can be diverted to the vehicle battery bank for recharging.

### IMAGES

FIG. 1.: Device 1, stator housing armature coil, internal battery paddles
1a shows the paddle alignment on the cylindrical device
1b. shows the magnets affixed to the inside of the cylinder
1c. show the stator windings
1d shows the battery core
1e. shows the terminals

FIG. 2.: Device 2, stator housing permanent magnets, hub-based armature coil rotor permanent magnet rotor
2a shows the position of the paddles.
2b. shows the relative position of the magnet that is affixed to the inner wall of the cylinder
2c. shows the rotor
2d show the shaft that allows the cylinder to spin
2e shows the terminals
2f. shows the windings
2g. shows the brushes

FIG. 3.: Paddle cylinder
3a shows the relative position of paddles to the cylinder

FIG. 4: sample generator placement Sample Device Placement
4a shows the placement of the device on the electric vehicle

FIG. 5.: shows the stator assembly

FIG. 6 vent ducting

FIG. 7 internal battery and permanent magnets

The primary way to configure this device is denoted in this application as Device 1. In the case of Device 1 this cylindrical device comprises an outer surface which houses the several fluid pressure paddles, rows of magnets that are attached to the inner surface of the cylinder, an inner armature winding that surrounds an internal battery bank. Device 1 the copper or enameled wire is wound tightly around an iron core center and fashioned such that it is encompassed by the paddle cover. This armature takes up a large percentage of the inner device. This assembly constitutes the stator body housing and has electrodes made of soft iron. This armature winding is completely concealed by the paddle wheel cover and is in the shape of the cylinder. This dense magnet wiring cluster forms the first major segment of the Device 1 generator. There are several layers of wire in this cluster. The armature coil is stationary. The magnetic field is created through electric current in the wire-wound coil and strengthened by a soft-iron core. The armature coil assembly converts the mechanical energy of the rotating paddle magnets into electrical energy by passing the permanent magnets through this armature winding. The paddle wheel, which turn the permanent magnets thus becomes the rotor. The Rotor produces rotating magnetic flux or rotating magnetic field associated with the rotor inducing electricity in the armature coil attached to the device or cylinder. The electricity produced is then diverted to the charge controller. The charge controller now powers the engine directly, charges the internal battery or recharges the vehicle battery based on the current needs of the vehicle. Permanent steel magnets attached to the inner wall of the cylinder are arranged at intervals around a center stator hub. Each permanent magnet is attached in sequence with respect to the center hub. Each magnet is adhered to the cylinder alternating the north and south pole orientation of each magnet. They are the second major segment and are arranged in a pattern of five or more spokes and adhered to the paddle wheel. The paddle wheels are designed such that in addition to housing the permanent magnets they transmit the power from the fluid, they represent the third major segment. The magnetic field directions generated by the permanent steel magnets are consistent and all face the inner side or the outer side of the rotor. The internal battery bank comprises the fourth major segment. This segment is hidden in the inside of the stator body.

A cylindrical device that has an outer layer of pressure paddles that are designed to harness the movement of fluids such that the device can convert motion into electricity. The inner wall of the device is lined with magnets which are configured so that they can spin around a center armature winding. The armature winding is comprised of copper or enameled wire that is wound tightly around an iron core and fashioned such that it encompasses a battery bank located in the center of the device. The paddle cover has a series of magnets affixed around the circumference of the inside of the cylinder. The armature makes up the center of the device. This assembly constitutes the stator body housing and has electrodes. This armature winding is completely concealed by the paddle cover. The armature coil assembly converts the mechanical energy of the rotating pressure paddle into electrical energy by passing the permanent magnets through this armature winding. The armature coil surrounds a battery bank. This rechargeable battery bank forms the second major segment of the Device 1 generator.

The pressure paddles are connected to the outside of the cylinder and are arranged such that they can capture the fluid passing over the device and thereby convert the fluid movement into kinetic energy which produces electricity. The pressure paddle assembly thus becomes the rotor. The Rotor produces rotating magnetic flux or rotating magnetic field associated with the rotor inducing electricity in the armature coil attached to the device. The electricity produced is then diverted to the charge controller. The charge controller now powers the engine directly, recharges the internal battery or recharges the vehicle battery based on the current needs of the vehicle. Pressure paddles are arranged at intervals around a cylindrical device. Each permanent magnet is attached in sequence to the inside wall of the cylindrical device. Each magnet is adhered to the inside wall of the cylindrical device alternating the north and south pole orientation of each magnet They are arranged in a pattern of five or more and adhered to the inside of the cylinder. The paddles are designed such that in addition to rotating the permanent magnets they transmit the power from the fluid to the device. The pressure paddle cylindrical case performs two functions. To hold the entire device. The whole weight of the device is concentrated on the center hub. The cylinder holds this hub and transfer the weight to center. The entirety of the inside of the cylinder case is covered by permanent magnets. The magnetic field directions generated by the permanent steel magnets are consistent and all face the inner side or the outer side of the rotor. A kind of frictionless paddle-based range extender and recharger for electric vehicles and generating electricity, dramatically increasing the electric vehicle driving range and greatly reducing or eliminating the need for recharging, effectively lowering the sprung weight of the vehicle and speeding recharge times. This paddle-based device creates magnetic lines inducing current Electrical conductors moving through a steady magnetic field, or stationary conductors within a changing magnetic field, will have circular currents induced within them by induction, called eddy currents. Eddy currents flow in closed loops in planes perpendicular to the magnetic field.

### DESCRIPTION

The present invention relates to a kind of paddle-based range extender and recharger for electric vehicles and generating electricity, dramatically increasing the vehicles driving range and greatly reducing or eliminating the need for recharging, this device is called the Grayson Range Extender (GRE) 2.0, belong to electrics technical field.

### BACKGROUND TECHNOLOGY

Although pure electric vehicles have the advantage of energy-savings, environmental protection, and zero discharge, the continual mileage range is currently very limited. In order to achieve mass application and acceptance the electric vehicle, the range must meet or exceed that of conventional fossil fuel powered vehicles. Currently 400 miles is the average range for a fossil fuel vehicle. This range has become standard and is very consumer friendly because of the fact that there is a wide choice of gas stations available and refueling takes only five minutes. It would be very easy to give gas cars a higher range, just put in a bigger tank. For electric vehicles the solution is not as simple. The average range of an electric vehicle is currently 150 miles. Adding more battery as the solution for perceived range needs only adds more cost to the profitability-challenged electrified vehicle. Vehicle Costs Already Too High for Mainstream Customers and given the inherent cost disadvantages faced by EV's vs. conventional vehicles and less financial policy support in the future, even the current $50 per additional mile of cost to the vehicle is quite impractical. given the number/frequency of trips that truly require most of the battery range. Larger batteries will also incur larger warranty expenses for the OEM as well as greater freight & recycling costs

More Mass on the Vehicle. Batteries are very heavy. Compensating with Lightweight Materials is Expensive. In order to meet very stringent fuel economy & CO2 targets globally (primarily China, Europe, US & CA), all vehicles will have to be lighter and more mass efficient Automotive OEM's will pay more in premium materials for weight savings. Adding 4 lbs. of battery mass is roughly equal to 1 mile of EV range.

Longer Charging Times to Top-off Charging Infrastructure for Long Distance Trips under currently under Development however no solution is close at hand.

Key Customers today are very accustomed to short re-fueling times at gas stations. Charging an EV is a much different experience and has been a challenge since the days of Edison's efforts to supply the first batteries for electric cars. The larger the batteries become, the more and faster charging solutions that are required and continuous high-power charging can increase battery degradation.

Less Packaging Space for other Components. More Stuff on Vehicles Expected with High Tech Features and Autonomous driving leaves less room for batteries and not more. As batteries become larger to provide more range, given a fixed vehicle size, packaging of components and new features become an acute challenge for all of the elements requiring space within the vehicle architecture including passenger and cargo carrying expectations. Future self-driving systems will further accentuate this issue as well as require more energy consumption

More Structural Requirements for Crashworthiness. Must Protect the Bigger Batteries. We are often reminded that both gas tanks and batteries contain so much energy and they need to be carefully protected from thermal events that can occur during crashes. Larger batteries are greater engineering challenges requiring more substantive structures/systems.

More Robust Support Systems Required Mass Begets Mass As the battery grows and the mass of the vehicle increases, other components from brakes, suspension, thermal management, etc. must be designed and reinforced to handle these challenges; the result is even more mass and cost added to the vehicle.

Without solutions to all these problems the electric vehicle just cannot advance. The GRE 2.0 addresses each of these problems in a practical, reliable and cost-effective way. My fluid dynamic paddle based permanent magnet generator has the advantage of high efficiency, high power density, and has more wide application prospect.

In existing technology, the GRE will prove to be a compatible device that can quickly integrate with all current electrical vehicle platforms. The present invention proposes the conversion of the vehicle fluid dynamics into rotational energy that moves a permanent magnet generator. In fluid dynamics, drag (sometimes called air resistance, a type of friction, or fluid resistance, another type of friction or fluid friction) is a force acting opposite to the relative motion of any object moving with respect to a surrounding fluid.

### SUMMARY OF THE INVENTION

In order to gain exponential range extension, provide more power for greater horsepower. create a platform that will have immediate and long-term environmental benefits while simultaneously reducing charging times, improving EV overall efficiency, the present invention adopts following technical scheme:

A kind of electric vehicle recharging system that greatly extends the range of any vehicle, said paddle-based range extender device, Grayson Range Extender (GRE) 2.0, is characterized in that: Comprise a cylindrical paddle cover-based permanent magnets, armature winding, charge controller and battery bank,

Magnetic conductive soft iron and permanent magnet are spaced and are bonded to the inner cylinder wall, a magnetic conductive soft iron and a set of permanent magnets pole, Permanent magnet has multi-spoke and in circular arc, the magnetic direction that all permanent magnets produce is consistent; In Device 1 the Armature winding is in the center of the device.

Quantity, the shape and size of described magnetic conductive soft iron are consistent with permanent magnet and size of the cylinder;

The cylinder device is positioned fixed on the vehicle body panels, such that the air flow will induce motion in the paddle wheel casing. Air ducts can be molded into the vehicle body panels to encourage and maximize air flow. The cylinder is fixed on the vehicle and as the paddle wheel rotates around the axel the rotor assembly in the cylinder can rotate around stator core casing thereby inducing electricity.

A kind of electric vehicle recharging system that greatly extends the range of any vehicle, said paddle-based range extender device, Grayson Range Extender (GRE) 2.0, as above, is characterized in that:

The permanent magnet and magnetic conductive soft iron can be mounted on the inside of the cylinder, this then becomes the stator assembly;

A rotor phase winding can be wrapped around the center hub of the cylinder;

Because this is a frictionless system the power produced is scalable to the desired recharge time and range

Beneficial Effect of the Present Invention is as Follows:

(1) system increases the range of an electric vehicle up to 400%;

(2) compared with traditional range extenders this device requires no additional fuels;

(3) compared with traditional generators this device has much greater charging capacity and reliability:

(4) compared with other types of recharging systems like regenerative breaking and bike generators, this system has lower coefficient of friction, generates a negligible amount of heat and is infinitely more reliable;

(5) can be very applicable and installed on all existing Electric Vehicles;

(6) compared to other range extenders this device lowers the sprung weight of the vehicle;

(7) compared to other range extenders this device has zero emissions

### EMBODIMENT

Below in conjunction with accompanying drawing, the invention is described in further details.

FIG. 1.: Device 1, stator housing armature coil, internal battery paddles
1a. shows the paddle alignment on the cylindrical device
1b shows the magnets affixed to the inside of the cylinder
1c. show the stator windings
1d. shows the battery core
1e shows the terminals

FIG. 2.: Device 2, stator housing permanent magnets, hub-based armature coil rotor permanent magnet rotor
2a. shows the position of the paddles.
2b shows the relative position of the magnet that is affixed to the inner wall of the cylinder
2c. shows the rotor
2d show the shaft that allows the cylinder to spin
2e shows the terminals
2f. shows the windings
2g. shows the brushes

FIG. 3: Paddle cylinder
3a shows the relative position of paddles to the cylinder

FIG. 4.: sample generator placement Sample Device Placement
4a shows the placement of the device on the electric vehicle

FIG. 5.: shows the stator assembly

FIG. 6 vent ducting

FIG. 7 internal battery and permanent magnets

### ACCOMPANYING DRAWING EXPLANATION

FIG. 1 is the sectional view of a kind of paddle-type electric vehicle generator range extender and recharger of the present invention, the Grayson Range Extender (GRE 2.0) Wherein

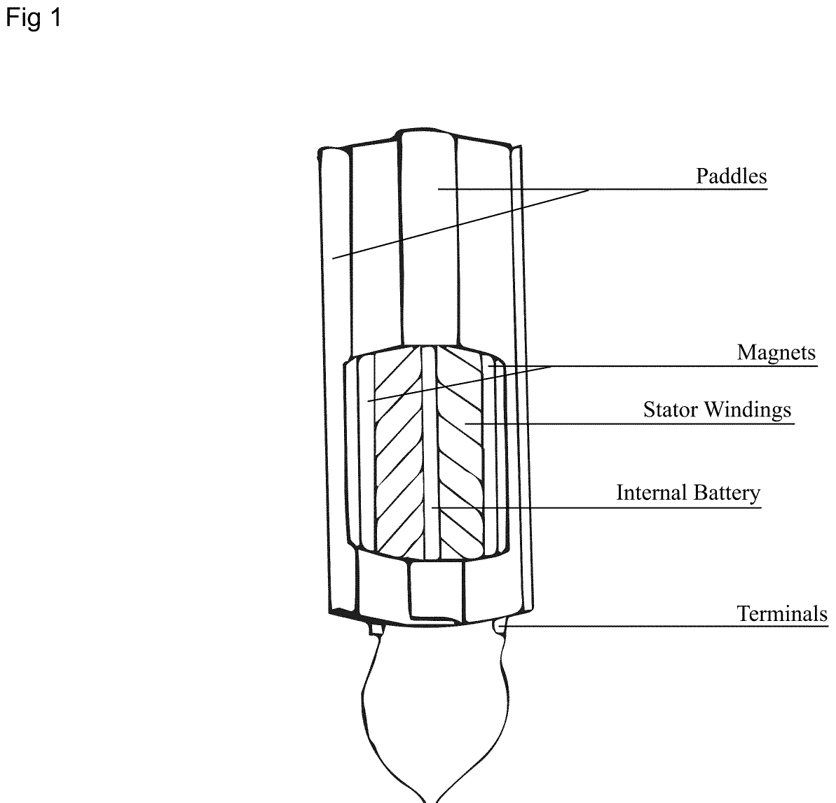

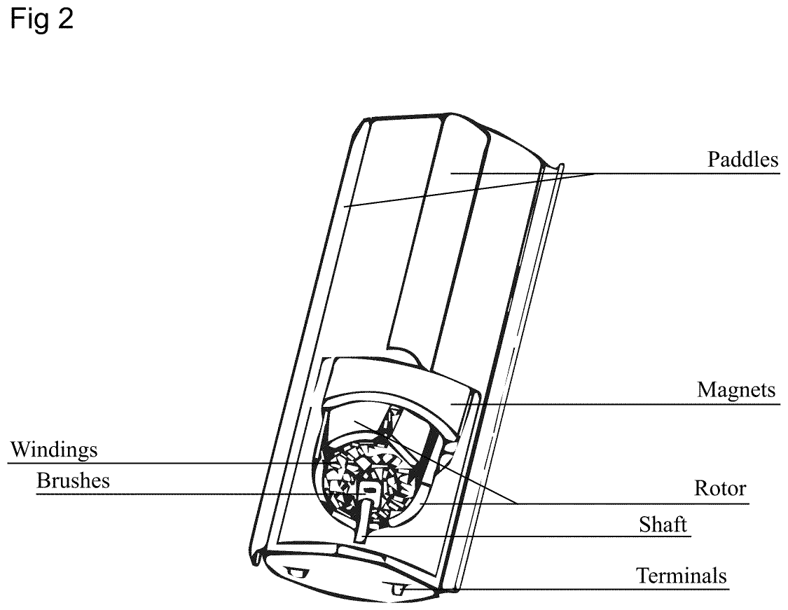

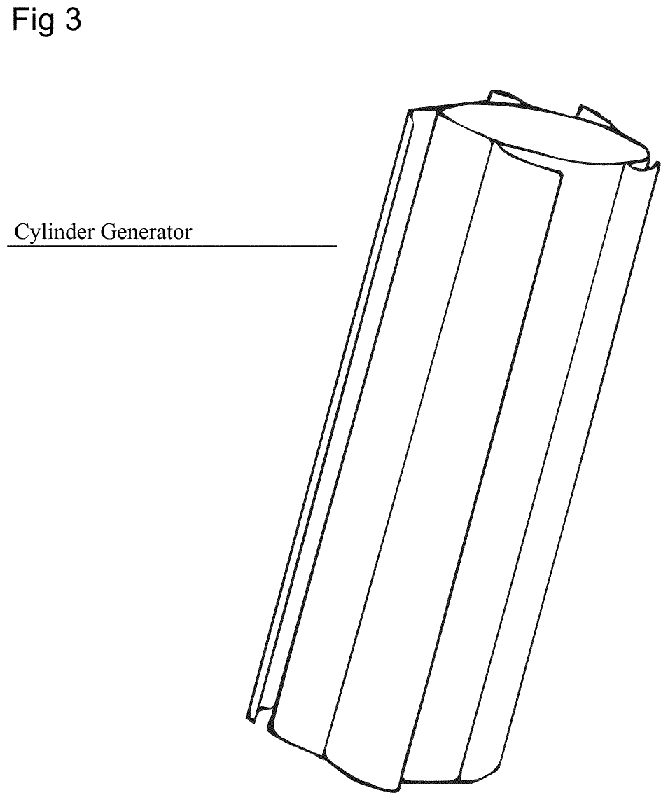

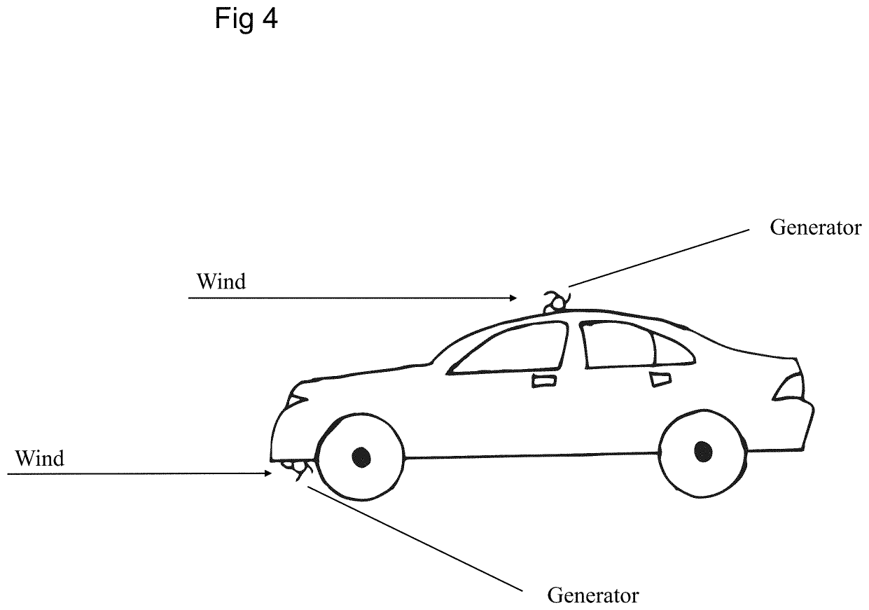

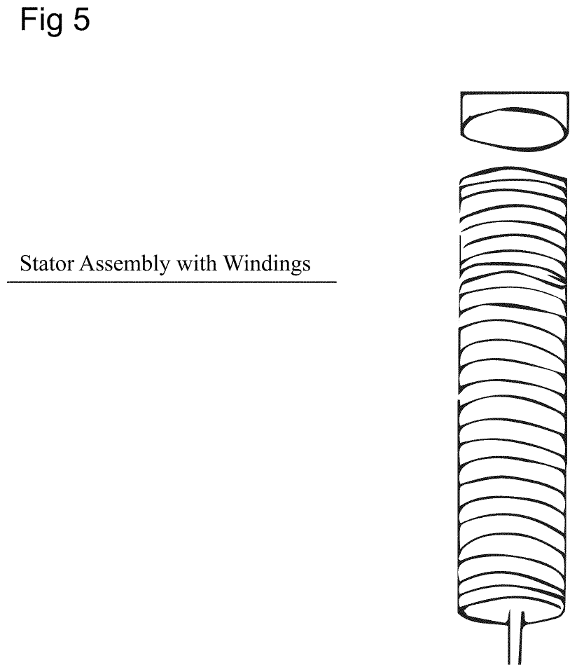

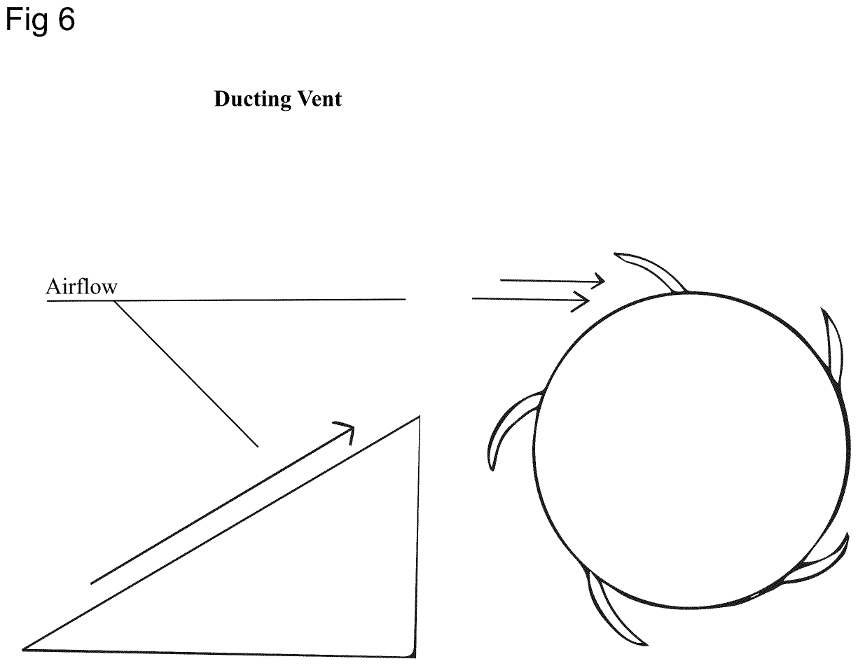

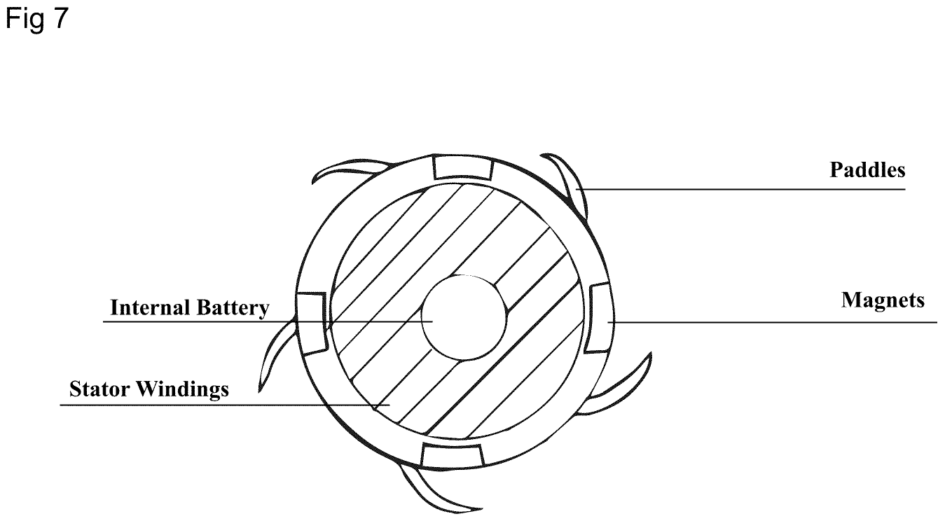

In the case of Device 1 the magnet wire or enameled wire is wound tightly around an iron core and fashioned such that it is encompasses an internal battery bank by the cylinder with paddle cover. This armature takes up a large percentage of the inside of the cylinder. This assembly constitutes the stator body housing. This armature winding is completely concealed by the paddle wheel cover and is in the shape of a cylinder. This dense magnet wiring cluster forms the first major segment of the Device 1 generator. There are several layers of wire in this cluster. The armature coil is stationary.

The rotor in comprised or permanent magnets which are incorporated in the rotating cylinder.

The armature coil assembly converts the mechanical energy of the rotating cylinder into electrical energy bypassing the magnets through this armature winding.

Said cylinder, which houses the permanent magnets in the underside. The cylinder thus becomes the rotor. The Rotor produces rotating magnetic flux or rotating magnetic field associated with the rotor inducing electricity in the armature coil attached to the paddle wheel.

Electrodes made of soft iron and permanent steel magnets are arranged at intervals around the inside of the paddle wheel. Each permanent magnet is attached in sequence to the upper portion of the cylinder. Each magnet is placed on the inside of the paddle wheel alternating the north and south pole of each magnet. They are arranged in a pattern of four or more spokes and adhered on the upper side of the paddle wheel. The paddles are designed such that in addition to moving the permanent magnets they transmit the power from the fluid hub to the battery.

FIG. 2 THE PADDLE WHEEL, is the sectional view of a kind of wheel-type electric vehicle generator range extender and recharger of the present invention, the Grayson Range Extender (GRE). Wherein:

In the case of Device 1 the magnet wire or enameled wire is wound tightly around an iron core and fashioned such that it encompasses the internal battery. This armature unwinding takes up a large percentage of the inside of the cylinder. This assembly constitutes the stator. This dense magnet wiring cluster forms the first major segment of the Device 1 generator. There are several layers of wire in this cluster. The stator is comprised of wiring clusters around each center hub.

The magnetic rotor converts the mechanical energy of the rotating paddle cylinder into electrical energy by passing the permanent magnet cluster through the armature winding.

Said paddle wheel, which houses the permanent magnet. The paddle wheel thus becomes the rotor. The Rotor produces rotating magnetic flux or rotating magnetic field associated with the rotor inducing electricity in the permanent magnet cluster attached to the paddle wheel.

Electrodes made of soft iron and tightly wired armature spokes are arranged at intervals around a center internal battery hub. Each armature spoke is attached in sequence to the center hub.

The stator is comprised of permanent magnets which are incorporated in the center of the paddle wheel. The stator assembly converts the mechanical energy of the rotating paddle into electrical energy by passing the permanent magnet assembly through the armature coil. The magnetic paddle wheel cluster is placed attached to the inside of the cylinder well alternating the north and south pole of each magnet

FIG. 3 THE PADDLE WHEEL GENERATOR,

is the view of a kind of PADDLE wheel-type electric vehicle generator range extender and recharger of the present invention, the Grayson Range Extender (GRE 2.0). Wherein:

the outside of the cylinder is symmetrically covered with contoured paddles that capture the fluid motion and rotate the permanent magnets around the center stator housing.

FIG. 4 THE SAMPLE PLACEMENT

It is the view of a kind of wheel-type electric vehicle generator range extender and recharger of the present invention, the Grayson Range Extender (GRE 2.0) Wherein

Showing the sample placement of the paddle wheel device on a sample electric vehicle. The device in this example is placed such that the device maximizes its ability to collect the fluid generated by the moving vehicle

FIG. 5 THE STATOR ASSEMBLY

The stator assembly is wound around the internal magnet. The rotor will create magnetic lines inducing current in the stator assembly. Electrical conductors moving through a steady magnetic field. or stationary conductors within a changing magnetic field, will have circular currents induced within them by induction. called eddy currents. Eddy currents flow in closed loops in planes perpendicular to the magnetic field

The stator assembly is connected to a Charge Controller. The electricity produced is then diverted to the charge controller. The charge controller now powers the engine directly or recharges the battery based on the needs of the pre-programmed needs vehicle. A charge controller, charge regulator or battery regulator limits the rate at which electric current is added to or drawn from electric batteries. It prevents overcharging and may protect against overvoltage, which can reduce battery performance or lifespan and may pose a safety risk. It may also prevent completely draining (“deep discharging”) a battery, or perform controlled discharges, depending on the battery technology, to protect battery life. The terms “charge controller” or “charge regulator” may refer to either a stand-alone device, or to control circuitry integrated within a battery pack, battery-powered device, or battery charger. The charge controllers may also be called a power regulator. The charge controller has additional features, such as a low voltage disconnect (LVD), a separate circuit which powers down the load when the batteries become overly discharged (some battery chemistries are such that over-discharge can ruin the battery). A series charge controller or series regulator disables further current flow into batteries when they are full A shunt charge controller or shunt regulator diverts excess electricity to an auxiliary or “shunt” load, such as an electric water heater, when batteries are full Simple charge controllers stop charging a battery when they exceed a set high voltage level, and re-enable charging when battery voltage drops back below that level. Pulse width modulation (PWA) and maximum power point tracker (MPPT) technologies are more electronically sophisticated. adjusting charging rates depending on the battery's level, to allow charging closer to its maximum capacity. A charge controller with MPPT capability frees the system designer from closely matching available PV voltage to battery voltage. Considerable efficiency gains can be achieved, particularly when the PV array is located at some distance from the battery. By way of example, a 150 volt PV array connected to an MPPT charge controller can be used to charge a 24 or 48 volt battery. Higher array voltage means lower array current, so the savings in wiring costs can more than pay for the controller. Charge controllers may also monitor battery temperature to prevent overheating. Some charge controller systems also display data, transmit data to remote displays, and data logging to track electric flow over time. Circuitry that functions as a charge regulator controller may consist of several electrical components, or may be encapsulated in a single microchip, an integrated circuit (IC) usually called a charge controller IC or charge control IC.

is the sectional view of a kind of wheel-type electric vehicle generator range extender and recharger of the present invention, the Grayson Range Extender (GRE). Wherein:

FIG. 6 THE DUCTING VENT

The fluid flow is controlled and minimized by using but not limited to ducting, tubes, and ramps.

In this example the ramp is positioned so that the flow of fluids strikes the paddle at the right geometry for maximum rotational energy

FIG. 7. Sample Paddle Placement—movable front paddle wheel, is the sectional view of a kind of wheel-type electric vehicle generator range extender and recharger of the present invention, the Grayson Range Extender (GRE). Wherein:

the contoured paddles are placed on the outside of the cylinder,

the permanent magnets are secured to the inner wall of the cylinder

the stator windings occupy the interior of the device

and the internal battery is located at the very center of the device

Permanent magnet has multi-disc and in circular arc, the magnetic direction that all permanent magnets produce is consistent, Quantity, the shape and size of described magnetic conductive soft iron are consistent with permanent magnet.

The motor generator proposed the present invention below carries out the explanation of operation principle.

Motor basic functional principle of the present invention is identical with traditional permanent magnet generator

It is to be noted, the above; be only the specific embodiment of the present invention; but protection scope of the present invention is not limited thereto; any be familiar with those skilled in the art in the technical scope that the present invention discloses; the change that can expect easily and replacement, all should be encompassed in protection scope of the present invention. Therefore, protection scope of the present invention should be as the criterion with the protection range of described claim.

1. A fluid dynamic electricity producing electric generator range extending charging system comprising: A fluid directional ramp, gate and or ducting enclosure that directs and compresses the fluid so that it passes over the pressure paddles with maximum efficiency and pressure. This ramp enclosure comprises the first section of the device and ensures that the fluid strikes the paddles at the right angle. The pressure paddles which are connected to the outside of the cylinder and are arranged such that they can capture the fluid passing over the device and thereby convert the fluid movement into kinetic energy which produces electricity. The pressure paddle assembly thus becomes the rotor and the second section of the device. The inside of the cylinder wall is comprised of magnets. When the fluid strikes the paddles, the cylinder rotates the magnets around the stator armature coil. The Rotor produces rotating magnetic flux or rotating magnetic field associated with the rotor inducing electricity in the armature coil attached to the device. The armature coil is the third section of this device. The armature sits in the middle of the device and is stationary. The armature coil is wrapped around the charge controller assembly comprises the fourth section of this device. There is a reserve battery bank located inside the armature that is part of the charge controller assembly. This battery bank is the fifth section of this device. The electricity produced is diverted to the charge controller. The charge controller now powers the engine directly, recharges the internal battery or recharges the vehicle battery based on the current needs of the vehicle.

2. A rotating cylinder paddle-based rotor electric vehicle generator range extending charging system according to claim 1, wherein said device components of the present invention, as generally described could be arranged and designed in a wide variety of different configuration. The first primary design is such that an electric vehicle range extending charging system comprising.
A fluid ramp, gate and or ducting enclosure that directs and compresses the fluid so that it passes over the pressure paddles with maximum efficiency and pressure. This ramp can be built into the device or built into the electric vehicle.
Pressure paddles that are arranged at intervals around a cylindrical device. The paddles are designed such that in addition to rotating the permanent magnets they transmit the power from the fluid to the device. The pressure paddle cylindrical case performs two functions. To hold the entire device. The whole weight of the device is concentrated on the center hub. The cylinder holds this hub and transfer the weight to center.
Permanent magnets which are affixed to the inside of the cylinder Each permanent magnet is attached in sequence to the inside wall of the cylindrical device. Each magnet is adhered to the inside wall of the cylindrical device alternating the north and south pole orientation of each magnet. They are arranged in a pattern of five or more and adhered to the inside of the cylinder. The entirety of the inside of the cylinder case is covered by permanent magnets. The magnetic field directions generated by the permanent steel magnets are consistent and all face the inner side or the outer side of the rotor.
A coiled copper, magnet or enameled wire tightly wound around a sufficiently large armature which is housed inside the cylinder. Said armature passes through the paddle wheel cylinder. A rotating cylindrical paddle wheel-based permanent magnet rotor comprising of external paddle blades adhered to the outside of the cylinder and permanent magnets adhered to the inside of the cylinder. An armature which is housed inside the cylinder. The armature passes through the magnet rotor and thus passes through the magnets to create electricity. The armature is comprised of tightly wound wire.
A battery bank that is located in the center of the armature assembly.
A charge controller which directs the flow of electricity either to the vehicle, the internal battery, or the battery bank.
A charge controller which directs the flow of electricity either to the vehicle, the internal battery, or the battery bank.

3. The electric vehicle generator range extending charging system according to claim 1 and 2, wherein the fluid flow associated with the motion of the vehicle, fluid dynamic, resistance, wind and drag create a rotational energy in the cylinder this captured energy in turn powers the generator such that as the permanent magnets pass through the coil field of the copper wire electricity is produced.
